(19) United States
(12) Patent Application Publication
(10) Pub. No.: US 2006/0036712 A1
(43) Pub. Date: Feb. 16, 2006

(54) System and method for providing and utilizing presence information

(76) Inventor: Robert P. Morris, Raleigh, NC (US)

Correspondence Address: IPAC, 111 Corning Road, Suite 220, Cary, NC, 27511, US

(21) Appl. No.: 10/900,558

(22) Filed: Jul. 28, 2004

(51) Int. Cl. G06F 15/16

(52) U.S. Cl. 709/219

(57) ABSTRACT

A method and system for utilizing presence information with a device is described. In one aspect, the method and system include obtaining user information for a user and obtaining presence information for at least one entity associated with the user. The method and system also include displaying at least a first portion the presence information for the at least one entity only if the device includes a display capable of displaying the first portion of the presence information and presenting at least a second portion of the presence information in an alternative form if the device does not include the display. In another aspect, the method and system include allowing an activity related to a recipient be initiated by a user and determining a status of the recipient based on the identification information and in response to the activity being initiated by the user. In this aspect, the method and system also include presenting the status of the recipient to the user and allowing the user to alter the activity based upon the status of the recipient.

### CROSS-REFERENCE TO RELATED APPLICATIONS

The present application is related to co-pending U.S. patent application Ser. No. ______ [1257/3293P] entitled “SYSTEM AND METHOD FOR HARMONIZING CHANGES IN USER ACTIVITIES, DEVICE CAPABILITES AND PRESENCE INFORMATION” filed on ______ and assigned to the assignee of the present application.

### FIELD OF THE INVENTION

The present invention relates to instant messaging services and more particularly to providing and utilizing presence information on a client, particularly a multiple user device.

### BACKGROUND OF THE INVENTION

Instant messaging services provide a well known mechanism for allowing computer users to communicate online for example by sending a message or chatting with another user. Such services are typically provided by AOL, MSN, Yahoo, and other similar service providers. Certain data associated with a user of such instant messaging services is known as presence information. Presence information typically comprises of one or more presence tuples, which represent the status, an optional activity address, and other information relating to the user. The status of the user can simply be open or closed, when the computer system will or will not accept instant messages for the user. Other examples of the status of the user can include online, away from my desk, stepped out, or on the phone. Based on the status of a user, other users may decide whether to initiate activities with the user. Contact information can include contact addresses such as email address, ftp addresses, or postal addresses. More information on instant messaging and presence information can be found at the following sites: http://www.jabber.org/jeps/jep-0132.html, http://wwwjabber.org/jeps/jep-0119.html, http://www.ietf.org/internet-drafts/draft-ietf-impp-cpim-pidf-08.txt, http://www.ietf.org/rfc/rfc2778.txt, and http://www.ietf.org/rfc/rfc2779.txt.

As part of instant messaging services, a conventional friends list is often supported. Such a conventional friends list provides a user with presence information related to other entities (e.g. other users of the instant messaging service) who are associated with the user. More specifically, status information for the “friends” is provided in the friends list. For example, while a user is online, the conventional friends list is typically displayed in a window on the user's display. Using the friend's list, a user can determine whether to send a message to an entity on the friends list. For example, if a particular friend's status is busy or away from my desk, the user may opt not to attempt to start a chat session with that particular friend.

Although conventional instant messaging services and conventional friends lists are useful, one of ordinary skill in the art will readily recognize that there are significant barriers to adoption of such conventional instant messaging services to other uses. In particular, it may be difficult to obtain, display, and use presence information on other devices. For example, traditional phones are unable to connect to a server to retrieve information about either a user of the phone or entities on the user's friends list. Although phones with network connectivity are available, such telephones are also unsuitable for instant messaging or similar services for a number of reasons. For example, the conventional friends list is typically displayed throughout a user's time online. Other activity mechanisms, such as phones or digital imaging devices like digital cameras, typically do not have a large display or have no display at all. Thus, such devices may not have sufficient display to depict all of the information typically displayed in a conventional friend's list while performing other tasks. For example, a phone may have a display that is too small to display an entire friends list. Similarly, a digital camera may not be capable of adequately displaying the friends list while an image is being composed. Moreover, such devices may be shared between multiple users. Different users may have different friends lists. A mechanism for only presenting the appropriate friends list for the current user is desired. Thus, barriers exist to obtaining, displaying, and using presence information on other devices.

Accordingly, what is needed is a method and system for extending presence information to other devices. The present invention addresses such a need.

### BRIEF SUMMARY OF THE INVENTION

The present invention provides a method and system for utilizing presence information with a device. In one aspect, the method and system comprise obtaining user information for a user and obtaining presence information for at least one entity associated with the user. The method and system also comprise displaying at least a first portion the presence information for the at least one entity only if the device includes a display capable of displaying the first portion of the presence information and presenting at least a second portion of the presence information in an alternative form if the device does not include the display. In another aspect, the method and system comprise allowing an activity related to a recipient to be initiated by a user and determining a status of the recipient based on recipient identification information and in response to the activity being initiated by the user. In this aspect, the method and system also comprise presenting the status of the recipient to the user and allowing the user to alter the activity based upon the status of the recipient.

According to the method and system disclosed herein, the present invention allows presence information to be appropriately presented on and used in a variety of devices including, but not limited to, cellular telephones.

### BRIEF DESCRIPTION OF SEVERAL VIEWS OF THE DRAWINGS

FIG. 1 is a high-level flow chart of one embodiment of a method in accordance with the present invention for providing presence information to a user.

FIG. 2 is a high-level flow chart of another embodiment of a method in accordance with the present invention for providing presence information to a user.

FIG. 3 is a more detailed flow chart of one embodiment of a method in accordance with the present invention for providing presence information to a user and allowing the user to utilize the presence information.

FIG. 4 is a high-level block diagram of one embodiment of a system in accordance with the present invention for providing presence information to a user.

FIG. 5 is a high-level block diagram of one embodiment of a service in accordance with the present invention for providing presence information to a user.

FIG. 6 is a more detailed diagram of the interaction between the system and the service in accordance with the present invention.

### DETAILED DESCRIPTION OF THE INVENTION

The present invention relates to instant message services. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for utilizing presence information with a device. In one aspect, the method and system comprise obtaining user information for a user and obtaining presence information for at least one entity associated with the user. The method and system also comprise displaying at least a first portion the presence information for the at least one entity only if the device includes a display capable of displaying the first portion of the presence information and presenting a second portion of the presence information in an alternative form if the device does not include such a display. In another aspect, the method and system comprise allowing an activity related to a recipient to be initiated by a user and determining a status of the recipient based on identification information for the recipient and in response to the activity being initiated by the user. In this aspect, the method and system also comprise presenting the status of the recipient to the user and allowing the user to alter the activity based upon the status of the recipient.

The present invention will be described in terms of a particular method having certain steps. However, one of ordinary skill in the art will readily recognize that a method in accordance with the present invention can include other and/or additional steps not inconsistent with the present invention. Similarly, the present invention will be described in terms of particular devices, such as cellular or other telephones and digital cameras. However, one of ordinary skill in the art will readily recognize that the method and system in accordance with the present invention can include other and/or additional components not inconsistent with the present invention.

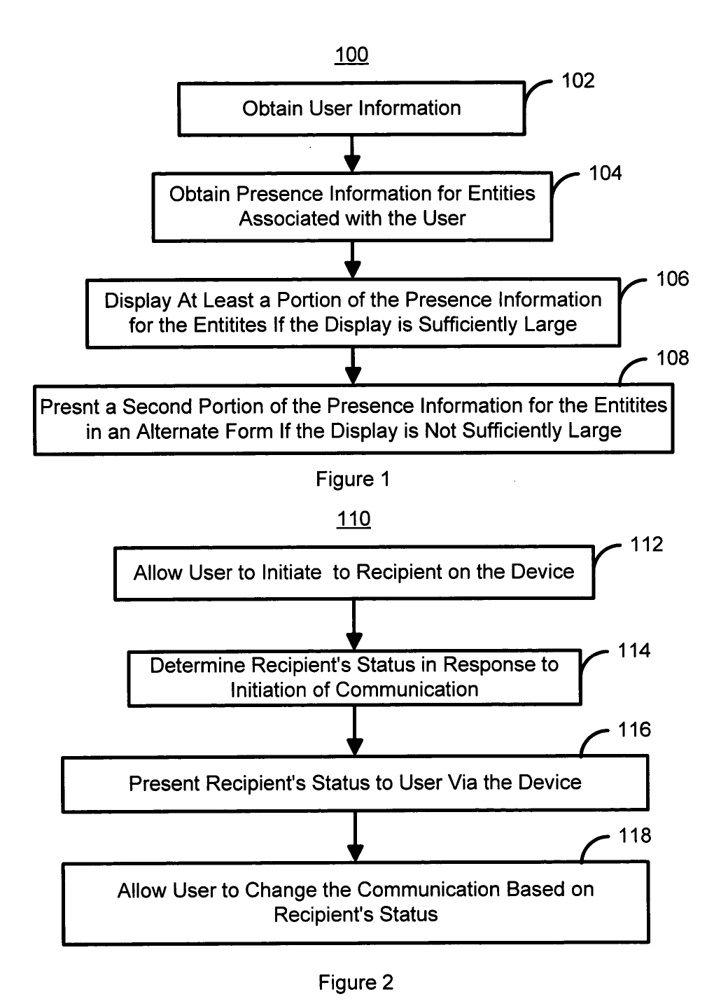

To more particularly describe the method and system in accordance with the present invention, refer to FIG. 1, depicting a high-level flow chart of one embodiment of a method 100 for providing presence information to a user on a device. In one embodiment, the device is a telephone having data capabilities, such as a mobile phone having such capabilities. In alternate embodiment, the device might be a digital imaging device such as a digital camera, or other device having data capabilities. The method 100 may commence in response to an activity being initiated by a user, or principal, of the device. Such an activity may be a communication that might include a phone call or an email being started. User information for a user is obtained, via step 102. The user information includes the identity of the user. Thus, the user may enter a password associated with the user, press a particular function key, or otherwise be identified in step 102. In addition, step 102 may include accessing a presence service, analogous to an instant messaging service. In such an embodiment, the user may identify themselves to the presence service. In addition to identifying the user, in one embodiment, step 102 may include obtaining presence information for the user.

Presence information for one or more entities associated with the user is obtained, via step 104. In one embodiment, the entities are those on the user's friends list. However, another mechanism might be used to associate the entities with the user. In some embodiments, the retrieval of the presence information could be associated with the purpose of the device, the type of activity, and/or the location of the device. Consequently, the device identification, device location, and/or device/activity type could be utilized with or without the user information to determine the presence information that should be retrieved. For example, a user could pick up a phone at a location such as an airport and retrieve the information for his travel agent, his emergency contact, his home, and/or airport security. Similarly, an emergency phone on a highway could retrieve presence information for the police, ambulance service(s), towing service(s) in response to the use of the phone. Step 104 may thus include accessing a presence service and obtaining presence information for the entities from the service. In one embodiment, step 104 is performed only if the device includes a display capable of displaying at least some part the presence information.

At least a first portion of the presence information is displayed if the device includes a display capable of displaying the first portion of the presence information, via step 106. In step 106, the presence information may be simply depicted on the device or may be accessed through a menu or other method of bringing up the appropriate display. The portion of the presence information displayed in step 106 may not include all of the presence information obtained in step 104 and/or may be for only a portion of the entities associated with the user. For example, status information for and the identity of one or more of the entities may be displayed in step 106. If the device does not include a sufficiently large display, then a second portion of the presence information is presented in an alternate form, via step 108. The alternate form used in step 108 does not make use of a display to display the second portion of the presence information in its entirety. However, the alternate form could be visual in nature. For example, an audio of the second portion of the presence information could be played and/or certain LEDs could be lit in order to indicate that the presence information is available.

Using the method 100, presence information for other entities, such as those on a friends list, may be obtained and displayed or presented on other device(s), such as a cell phone or digital camera. In addition, because the user identity is obtained, the method 100 allows presence information for entities associated with the user to be provided on devices having multiple users. Moreover, the method 100 may be performed in response to an activity being initiated. Thus, the presence information for the other entities may not be presented at all times that the user utilizes the device. Instead, the display of the device can be used for other purposes when a particular activity has not been initiated.

FIG. 2 is a high-level flow chart of another embodiment of a method 110 in accordance with the present invention for providing presence information to a user of a device. In one embodiment, the device is a telephone having data capabilities. In alternate embodiment, the device might be a digital imaging device such as a digital camera, or other device having data capabilities. An activity related to a recipient is initiated by the user of the device, via step 112. The activity is preferably a communication to a recipient. Such a communication might include a phone call or an email being started. Presence information, most particularly the status, for the recipient of the activity is obtained preferably from the presence service, via step 114. Step 114 is preferably performed in response to the activity being initiated in step 112. At least the status of the recipient is obtained in step 114. However, other presence information might also be obtained. In one embodiment, step 114 includes receiving an address and/or identification of the recipient from the user and mapping the address and/or identification information to the identity of the recipient, if necessary. The mapping may not be needed if the presence information is indexed by the presence service based upon the address or identification information. The status and, in some embodiments, other presence information are requested from the presence service and received from the presence service in step 114. The status of the recipient is presented to the user via the device, via step 116. Step 116 is generally performed prior to communication being established with the recipient. If the device includes a display, then the status of the recipient might be depicted on the display. The status might also be provided via audio or another mechanism. The user is then allowed to alter the activity based upon the status of the recipient, via step 118. For example, the user may decide to stop the activity, go straight to the recipient's voicemail, to send an email in lieu of a telephone call or vice versa.

Using the method 110, presence information for the recipient may be obtained and employed by a user of the device to improve the efficiency of activity. In particular, the user is informed of the status of the entity or entities with which the user is communicating. As a result, a user may make choices, for example terminating the activity, thereby improving the efficiency of activity. Further, the steps in the method 110 are performed in response to the activity, such as a communication, being initiated. Thus, efficiency of the device is further improved. For example, the display of the device can be used for other purposes when a communication has not been initiated. Moreover, because the status or other presence information may be presented in a variety of fashions, including methods which do not use a display, the method 110 may be used by devices that do not have a display.

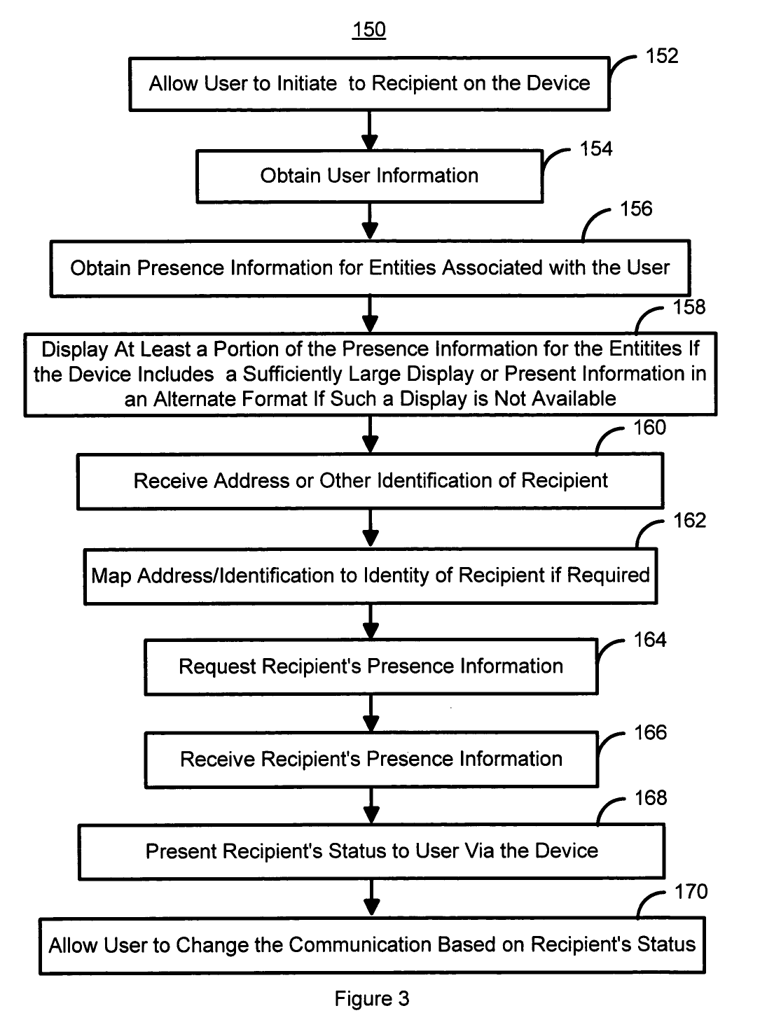

FIG. 3 is a more detailed flow chart of one embodiment of a method 150 in accordance with the present invention for providing presence information to a user via a device and allowing the user to utilize the presence information. In one embodiment, the device is a telephone having data capabilities. In alternate embodiment, the device might be a digital imaging device such as a digital camera, or other device having data capabilities.

An activity related to a user is initiated by the user of the device, via step 152. The activity is preferably a communication to a recipient. Such a communication might include a phone call or an email being started. User information, particularly the identity of the user, is determined, via step 154. For example, the user may press a function key identifying the user, enter a password, or otherwise provide their identity. Presence information for one or more entities associated with the user is obtained, via step 156. In one embodiment, the presence information might be obtained in step 156 only if the device includes a display sufficiently large to display the presence information. The information is obtained in step 156 only if the device can display the presence information. In one embodiment, the entities are those on the user's friends list. However, another mechanism might be used to associate the entities with the user. In some embodiments, the retrieval of the presence information could be associated with the purpose of the device, the type of activity, and/or the location of the device. Examples of such associations are described above. Step 156 may thus include accessing a presence service and obtaining presence information for the entities from the service.

At least a portion of the presence information is displayed if the device includes a display sufficiently large to display the portion of the presence information and otherwise presents a second portion of the presence information in an alternate form, via step 158. In step 158, the presence information may be simply depicted on the device or may be accessed through a menu or other method of bringing up the appropriate display. The portion of the presence information displayed in step 158 may not include all of the presence information and/or may be for only a portion of the entities associated with the user. For example, status information for one or more of the entities may be displayed in step 158. The alternate form used in step 158 does not make use of a display to display the second portion of the presence information in its entirety. However, the alternate form could be visual in nature. For example, an audio of the second portion of the presence information could be played and/or certain LEDs could be lit in order to indicate that the presence information is available.

The address of or other identification information for the recipient is received, via step 160. The address or identification information is preferably received from the user. Such information might include the phone number of the call being placed. In one embodiment, step 160 includes receiving an address and/or identification of the recipient from the user. The address and/or other identification information are mapped to the identity of the recipient, if necessary, via step 162. The mapping may not be needed if the presence information is indexed by the presence service based upon the address or identification information. Presence information for, most particularly the status of, the recipient related to the activity is requested preferably from the presence service, via step 164. At least the status of the recipient is received in step 166. However, other presence information might also be received. The status of the recipient is presented to the user via the device, via step 168. If the device includes a display, then the status of the recipient might be depicted on the display. Otherwise, the status might be provided via voice, a display, or other mechanism. The user is then allowed to alter the activity based upon the status of the recipient, via step 170. For example, the user may decide to stop the activity, go straight to the recipient's voicemail, to send an email in lieu of a telephone call or vice versa.

For example, the method 150 may proceed as follows. A user wishes to call his/her boss from home phone (it has a small LCD screen), but does not know if the boss is in. The user picks up the receiver and presses a programmable function key which identifies him/herself as the caller in step 152. The user enters the boss's phone number. The presence information, including status, for the boss is received in step 166 and displayed in step 188. Thus, before the call is put through the boss's status, “Back in 5 minutes”, is displayed in step 168. The caller may hear the status via audio in step 168 instead of or in addition to seeing it displayed. In step 170, the user decides to hang up and call again in 5 minutes rather than getting the boss's voice-mail and leaving a message. Similarly, a user may wish to contact his/her boss but doesn't want to interrupt anything that may be ongoing. The user starts an Instant Message on his/her mobile phone in step 152. The user enters the boss's IM name in step 160. The boss's presence information is queried using the IM name in steps 162-166 and determines that the boss is in and not busy. In steps 168 and 170, the user is informed that the boss is in and not busy and, therefore, opts to initiate a phone call instead of sending an instant message

Using the method 150, presence information for other entities, such as those on a friends list, may be obtained and displayed on other device(s), such as a cell phone or digital camera. In addition, because the user identity is obtained, the method 150 allows presence information for entities associated with the user to be provided on devices having multiple users. Presence information for the recipient may also be obtained and employed by a user of the device to improve the efficiency of activity. In particular, the user is informed of the status of the entity or entities related to the user's activity. As a result, a user may make choices, for example terminating the activity, thereby improving the efficiency of activity. Further, the steps in the method 150 are performed in response to the activity being initiated. Thus, efficiency of the device is further improved. For example, the display of the device can be used for other purposes when the activity has not been initiated. Moreover, because the status or other presence information may be presented in a variety of fashions, including methods which do not use a display, the method 150 may be used by devices that do not have a display.

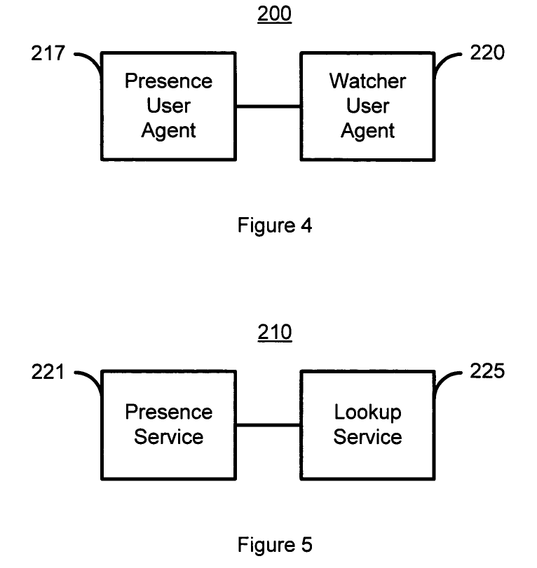

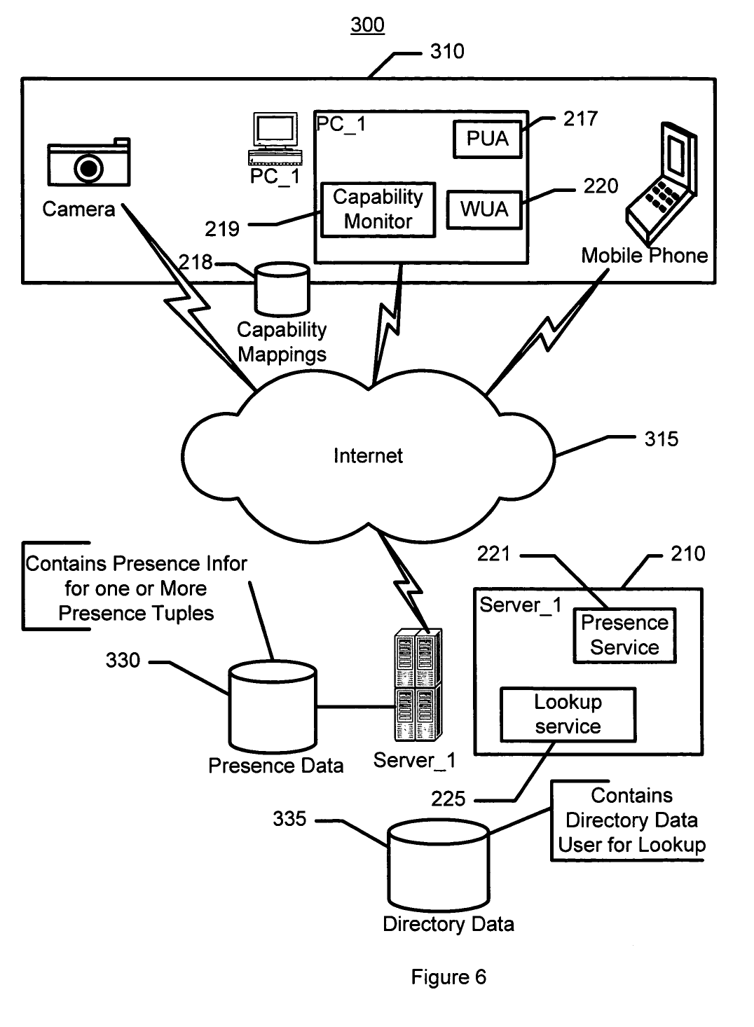

FIG. 4 is a high-level block diagram of one embodiment of a system 200 in accordance with the present invention for providing presence information to a user. The system 200 may be implemented by a device, such as a telephone, digital imaging device, or personal computer. The system 200 includes a presence user agent 217 and a watcher user agent 220. The presence user agent 217 communicates with and on behalf of the user. The watcher user agent 220 receives data from a service. Functions of the presence user agent 217 and the watcher user agent 220 will also be described below, in FIG. 6.

FIG. 5 is a high-level block diagram of one embodiment of a service 210 in accordance with the present invention for providing presence information to a user. The service 210 includes a presence service 221 and a lookup service 225. The presence service 221 and the lookup service 225 may be integrated or independent and may or may not be run on the same server. The presence service 221 communicates with the system 200 of FIG. 4 to receive the necessary information, such as user identification or recipient address information, and to provide presence information to the system 200. The lookup service 225 takes address information as an input and returns a key for the associated presence tuple. For example, the lookup service 225 would be used to map a phone number to a user name, which the presence service 221 would use to retrieve the associated presence tuple. Functions of the presence service 221 and the lookup service 225 will also be described below, in FIG. 6.

FIG. 6 is a more detailed diagram of the interaction between the system and the service in accordance with the present invention 300. Thus, the systems 200 and 210 of FIGS. 4 and 5, respectively, are depicted in FIG. 6. The system 200 can be implemented in the devices, the camera, the mobile phone and the PC, collectively referred to as devices 310. For clarity, only the PC is depicted as including the system 200. In addition, a capability monitor 219, which interfaces with capability mappings 218, is also provided. The overall system 300 indicates that activity is provided between the systems 200 and 210 via the internet 315. However, note that another mechanism, including an internal network, might be used.

The service 210 interfaces with presence data 330 and directory data 335. The presence data 330 and directory data 335 may be implemented on the same or different databases. The presence data includes presence information, preferably in the form of presence tuples that are preferably indexed using the identity of the corresponding entity (or user). The directory data 335 includes information used in lookups.

In operation, the presence user agent 217 and watcher user agent 220 implement most of the methods 100, 110, and 150. In particular, the watcher user agent 220 can obtain user information including a user identity for a user, can obtain presence information for the at least one entity, display at least a portion the presence information for at least one entity if the device includes a sufficiently large display, present at least a second portion of the presence information in an alternate form if the device does not include such a display, receive a status of the recipient based on the identification information, and presenting the status of the recipient to the user. The presence user agent 217 communicates with the user, provides an identification of the user, indicates that an activity related to a recipient is initiated by the user, and allows the user to alter the activity based upon the status of the recipient.

Thus, using the system 300, presence information for other entities, such as those on a friends list, may be obtained and, where appropriate displayed on the device. In addition, presence information for the recipient may be obtained and employed by a user of the device to improve the efficiency of activity. Further, the system 300 may be used to perform one or more of the methods 100, 110, and 150. Consequently, the benefits of the methods 100, 110, and 150 may be achieved.

A method and system for providing and utilizing presence information has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A method for utilizing presence information with a device comprising:
obtaining user information for a user;
obtaining presence information for at least one entity associated with the user;
displaying at least a first portion the presence information for the at least one entity only if the device includes a display capable of displaying the first portion of the presence information; and
presenting at least a second portion of the presence information in an alternative form if the device does not include the display.

2. The method of claim 1 wherein the user information includes user presence information.

3. The method of claim 1 further including:
allowing an activity related to a recipient to be initiated by the user.

4. The method of claim 3 wherein the user information obtaining step further includes:
determining an identity of the user.

5. The method of claim 4 wherein the presence information displaying step is performed in response to the activity being initiated.

6. The method of claim 3 further comprising:
determining recipient information for the recipient.

7. The method of claim 6 wherein the recipient information includes an identity of the recipient.

8. The method of claim 6 wherein the recipient information includes a status of the recipient and wherein the method further includes
presenting the status of the recipient.

9. The method of claim 8 wherein the device can be used by more than one user.

10. The method of claim 1 wherein the device can be used by more than one user.

11. The method of claim 1 wherein the device is a telephone.

12. A method for utilizing presence information with a device comprising:
allowing an activity related to a recipient to be initiated by a user;
determining a status of the recipient based on identification information and in response to the activity being initiated by the user;
presenting the status of the recipient to the user.

13. The method of claim 12 further comprising:
allowing the user to alter the activity based upon the status of the recipient.

14. A method for utilizing presence information with a device comprising:
allowing an activity related to a recipient to be initiated by a user;
obtaining user information for the user, the user information including an identity of the user;
obtaining presence information for at least one entity associated with the user;
displaying at least a portion the presence information for the at least one entity only if the device includes a display capable of displaying the first portion of the presence information;
presenting at least a second portion of the presence information in an alternative form if the device does not include the display;
obtaining identification information for the recipient;
determining a status of the recipient based on the identification information;
presenting the status of the recipient to the user; and
allowing the user to alter the activity based upon the status of the recipient.

15. A system for allowing a device to utilize presence information comprising:
a presence user agent for communicating with a user and for communicating on behalf of the user;
a watcher user agent for obtaining user information for the user, obtaining presence information for the at least one entity associated with the user, for displaying at least a first portion the presence information for at least one entity only if the device includes a display capable of displaying the first portion of the presence information, and for presenting at least a second portion of the presence information in an alternative form if the device does not include the display.

16. The system of claim 15 wherein the user information includes user presence information.

17. The system of claim 15 wherein the presence user agent further indicates that an activity related to a recipient is initiated by the user.

18. The system of claim 17 wherein the presence user agent provides identity information and the watcher user agent further receives an identity of the user based on the identity information.

19. The system of claim 18 wherein the watcher user agent obtains and displays the presence information in response to the activity being initiated.

20. The system of claim 17 wherein the watcher user agent further receives recipient information for the recipient.

21. The system of claim 20 wherein the recipient information includes an identity of the recipient.

22. The system of claim 21 wherein the recipient information includes a status of the recipient and wherein the watcher user agent further presents the status of the recipient to the user.

23. The system of claim 22 wherein the device can be used by more than one user.

24. The system of claim 15 wherein the device can be used by more than one user.

25. The system of claim 15 wherein the device is a telephone.

26. The system of claim 15 wherein the present user agent and the watcher user agent reside on the device.

27. A system for utilizing presence information for a device comprising:
a presence user agent for communicating with a user and providing a notification of an activity related to a recipient initiated by a user; and
a watcher agent for receiving a status of the recipient based on the identification information and in response to the activity being initiated by the user, and for presenting the status of the recipient to the user.

28. The system of claim 27 wherein the presence user agent further allows the user to alter the activity based upon the status of the recipient.

29. A system for utilizing presence information for a device comprising:
a watcher user agent for obtaining user information including a user identity for a user, obtaining presence information for the at least one entity associated with the user, for displaying at least a first portion the presence information for at least one entity only if the device includes a display capable of displaying the first portion of the presence information, presenting at least a second portion of the presence information in an alternative form if the device does not include the display, receiving a status of the recipient based on the identification information, and presenting the status of the recipient to the user; and
a presence user agent for communicating with the user, for providing an identification of the user, indicating that an activity related to a recipient is initiated by the user, and for allowing the user to alter the activity based upon the status of the recipient.

30. A system for providing presence information with a device comprising:
a lookup service for locating user information and presence information for at least one entity associated with the user and at least one recipient related to activity an activity initiated by the user, the user information including a user identity for the user, the presence information for the recipient including a status of the recipient;
a presence service for sending the user information and the presence information to the device in response to a notification that the user;
a user agent for obtaining user information including a user identity for a user, obtaining presence information for the at least one entity, for displaying at least a portion the presence information for at least one entity only if the device includes a display capable of displaying the first portion of the presence information, presenting at least a second portion of the presence information in an alternative form if the device does not include the display, obtaining identification information for the recipient, receiving a status of the recipient based on the identification information, and presenting the status of the recipient to the user; and
a presence user agent for communicating with the user, for providing an identification of the user, indicating that an activity related to a recipient is initiated by the user, and for allowing the user to alter the activity based upon the status of the recipient.

31. A computer-readable medium containing a program for utilizing presence information with a device, the program including instructions for:
obtaining user information for a user;
obtaining presence information for at least one entity associated with the user; and
displaying at least a first portion the presence information for the at least one entity only if the device includes a display capable of displaying the first portion of the presence information; and
presenting at least a second portion of the presence information in an alternative form if the device does not include the display.

32. The computer-readable medium of claim 31 wherein the user information includes user presence information.

33. The computer-readable medium of claim 31 wherein the program further includes instructions for:
allowing an activity related to a recipient to be initiated by the user.

34. The computer-readable medium of claim 33 wherein the user information obtaining instructions further include instructions for:
determining an identity of the user.

35. The computer-readable medium of claim 34 wherein the presence information displaying instructions are performed in response to the activity being initiated.

36. The computer-readable medium of claim 33 wherein the program further includes instructions for:
determining recipient information for the recipient.

37. The computer-readable medium of claim 36 wherein the recipient information includes an identity of the recipient.

38. The computer-readable medium of claim 36 wherein the recipient information includes a status of the recipient and wherein the program further includes instructions for:
presenting the status of the recipient.

39. The computer-readable medium of claim 38 wherein the device can be used by more than one user.

40. The computer-readable medium of claim 31 wherein the device can be used by more than one user.

41. The computer-readable medium of claim 31 wherein the device is a telephone.

42. A computer-readable medium containing a program for utilizing presence information with a device, the program including instructions for:
allowing an activity related to a recipient to be initiated by a user;
determining a status of the recipient based on identification information and in response to the activity being initiated by the user;
presenting the status of the recipient to the user; and
allowing the user to alter the activity based upon the status of the recipient.

43. A computer-readable medium containing a program for utilizing presence information with a device, the program including instructions for:
allowing an activity related to a recipient to be initiated by a user;
obtaining user information for the user, the user information including an identity of the user;
obtaining presence information for at least one entity associated with the user;
displaying at least a portion the presence information for the at least one entity only if the device includes a display capable of displaying the first portion of the presence information; and
presenting a second portion of the presence information in an alternative form if the device does not include the display;
obtaining identification information for the recipient;
determining a status of the recipient based on the identification information;
presenting the status of the recipient to the user; and
allowing the user to alter the activity based upon the status of the recipient.
